(19) United States
(12) Patent Application Publication
(10) Pub. No.: US 2018/0207050 A1
(43) Pub. Date: Jul. 26, 2018

(54) WALKING FRAME APPARATUS WITH PEDALS

(71) Applicant: James Leckey Design Limited, Lisburn (GB)

(72) Inventors: Laura Hamilton, Helen's Bay (GB); Colm Dobbs, Carryduff (GB)

(21) Appl. No.: 15/880,141

(22) Filed: Jan. 25, 2018

(30) Foreign Application Priority Data
Jan. 25, 2017 (GB) 1701279.0

(51) Int. Cl. A61H 3/00

(52) U.S. Cl. CPC A61H 3/008; A61H 2201/1652; A61H 2201/164

(57) ABSTRACT

A walking frame apparatus comprising a frame for supporting a user in a walking position, the frame having at least one ground-engaging portion; and a pedal apparatus coupled to the frame, the pedal apparatus comprising, an axle assembly comprising at least one ground-engaging wheel and first and second pedals which are coupled to the axle assembly.

### RELATED APPLICATIONS

This application claims priority to United Kingdom national application 1701279.0, filed Jan. 25, 2017, the disclosure of which is hereby incorporated herein by reference in its entirety.

### FIELD OF THE INVENTION

The present invention relates to walking frames and in particular to a walking frame incorporating a pedal apparatus.

### BACKGROUND

Children with cerebral palsy or complex developmental delay are less mobile than their peers. This lack of mobility can have a negative impact on muscle, bone and social development. The most common solution to these problems is the provision of a walking frame mounted on a plurality of wheels upon which the user can support themselves when walking. However there are a number of disadvantages with such basic frames, in particular relating to the atypical walking patterns the user will affect when using them which requires a lot of energy from the user and which can cause muscle shortening around the hips, knees and ankles, and pull lower limb joints into poor alignment reducing the overall effectiveness of the movement. Furthermore, the difficulties associated with using such a frame may discourage a person from using it often, which can result in diminished bone strength, particularly in non-ambulant children, due to the lack of weight bearing normally achieved when standing or walking. As a result of the above problems it is not uncommon for children, adolescents with cerebral palsy to lose the ability to walk.

It is therefore an object of the present invention to provide a walking frame which requires less energy from the user, which helps the user attain a more conventional walking pattern and which increases the users' enjoyment of walking such that they are more encouraged to pursue it.

### SUMMARY

Accordingly a first aspect of the present invention provides a walking frame apparatus comprising a frame for supporting a user in a walking position, the frame having at least one ground-engaging portion, a pedal apparatus coupled to the frame, the pedal apparatus comprising, an axle assembly comprising at least one ground-engaging wheel; and first and second pedals coupled to the axle assembly.

Preferably, the pedal apparatus is removably coupled to the frame.

Ideally, the frame has first and second spaced apart sides, the pedal apparatus being located between said first and second sides.

Preferably, each of said first and second sides of the frame has a ground-engaging portion comprising one or more wheels, rollers or slides.

Ideally, at least one ground-engaging wheel is coupled to at least one axle shaft.

Optionally, said first and second pedals are coupled to said at least one axle shaft by at least one linkage.

Ideally, said linkage is configured to translate substantially linear motion into rotational motion, the linkage preferably comprising a crank or pivoting member or any other suitable linkage.

Preferably, each of said pedals comprise a footplate which is shaped and dimensioned to accommodate each of the users feet.

Ideally, each of said footplates are pivotably coupled, preferably at one end, to each of the pedals.

Preferably, said footplates may comprise a strap which is configured to secure the users foot therein.

Ideally, the pedal apparatus is coupled to each of said first and second sides and extends between said first and second sides.

Optionally, said at least one axle shaft is coupled to each of said first and second sides of the frame.

Ideally, said axle assembly has first and second spaced apart axle shafts, both of said first and second pedals being coupled to both of said axle shafts.

Preferably, said first and second wheels are mounted on the, or each, axle shaft.

Ideally, the first and second pedals are located between said first and second wheels.

Ideally, the first and second pedals are coupled to said first and second axle shafts by the linkage, the linkage being configured such that each of the pedals are coupled to the axle shaft acentric or offset to the central axis defined by the ground engaging wheel.

Preferably, said pedals are located upon diametrically opposed sides of a central axis defined by the at least one ground engaging wheel such that when one pedal is at its lowest position the other pedal is at its highest position.

Ideally, the pedals are arranged to follow a rotational pattern defined by the acentric coupling to the axle shaft.

Preferably, the rotational pattern defined by the acentric coupling is an orbital pattern such as a substantially circular pattern.

Ideally, the first and second sides of the frame each comprise a wing portion to which the pedal apparatus is coupled.

Preferably, said frame comprises a transverse member which extends between the first and second sides to which the pedal apparatus is coupled, typically pivotably coupled.

Ideally, said pedal apparatus comprises a single ground-engaging wheel having a single axle shaft.

Preferably, the single ground engaging wheel is located between the first and second sides of the frame with the first and second pedals being located upon either side of the ground engaging wheel.

Ideally, the first and second pedals are each coupled to the axle shaft by respective, the linkages each preferably comprising an elongate member which is pivotably coupled to the axle shaft at one end and the first or second pedal at the opposing end.

Preferably, the linkages are configured such that each of the pedals are coupled to the axle shaft acentric to the central axis defined by the ground engaging wheel with the pedals being arranged upon the linkages such that they are located upon diametrically opposed sides of the central axis defined by the at least one ground engaging wheel such that when one pedal, for example, the second pedal is at its lowest position the other pedal is at its highest position

Ideally, the first and second pedals comprise elongate members which are coupled to the axle shaft at one end and at the opposing end have respective footplates provided thereon, towards the front of the apparatus.

Preferably, the first and second pedals comprise a ground engageable section such as a ball caster or roller or wheel or any other suitable apparatus, which is configured to contact and/or displace along the ground.

Ideally, the ground engageable section is located upon the underside of the pedals typically towards the front end of the pedals.

Preferably, the pedals are configured follow the rotational pattern defined by the acentric coupling to the axle shaft such as to establish a reciprocating motion of the pedals.

Ideally, the pedals are arranged such as to define an orbital pattern such as a substantially elliptical rotational pattern.

Preferably, wherein upon application of downward and/or upward force to either pedal in an alternating fashion such that the pedals are alternatively moved; the front end portions of the pedals, and more specifically the ground engageable caster of each pedal is configured to contact the ground in an alternating fashion wherein the pivoting coupling of the pedals to the axle shaft is configured to cause the pedals to rotate about the central axis defined by the ground engaging wheel such as to establish a reciprocating motion of the pedals, wherein the pedals, more specifically the forward end of the pedals upon which the footplates are disposed are operable to rotate in a substantially elliptical movement about the central axis, such that the ground engaging wheel rotates simultaneously with the ground engaging portions of the frame such as to enable movement of the apparatus in-use

Ideally, the pedal apparatus is located at the in-use bottom of the frame.

Preferably, a bracket is removably coupled to the frame, wherein the bracket comprises a coupling assembly configured to couple the user thereon.

Ideally, said bracket and/or the coupling assembly thereon is co-operable with a harness, provided upon the user such as to releasably couple the user upon said frame.

Preferably, said bracket comprises a base portion which is coupled to the frame and a central portion which is coupled, at least in part, to the base portion via a rail arrangement or any other suitable coupling arrangement which is configured to allow the central portion to slide or otherwise displace relative to the base portion such that the central portion may assume a plurality of extended or retracted positions.

Ideally, a steering arrangement is supported on the frame.

Preferably, said steering arrangement is disposed between the first and second sides of the frame.

Ideally, said steering arrangement is located in front of the user in-use.

Preferably, the pedal apparatus further comprises a frame assembly comprising a base portion and a rear portion.

Ideally, the base portion comprises spaced apart first and second members which define a channel therebetween within which the single ground engaging wheel is located.

Preferably, the first and second pedals comprise respective displacement assembly which are configured to engage the spaced apart first and second members respectively, wherein the displacement assembly are configured to allow the pedals to displace in a linear fashion along respective portions of the first and second members.

Ideally, the first and second pedals are movably coupled to the first and second members respectively by the respective displacement assembly.

Preferably the displacement assembly comprise a roller.

Ideally, each of the displacement assembly further comprises a stopper which is operable to engage with the spaced apart first and second members to prevent the pedals from being removed therefrom in-use.

A second aspect of the present invention provides a pedal apparatus for coupling to a frame, the pedal apparatus comprising, an axle assembly comprising at least one ground-engaging wheel; and first and second pedals coupled to the axle assembly.

### BRIEF DESCRIPTION OF THE DRAWING FIGURES

The invention will now be described by way of example with reference to the following drawings, in which like numerals are used to denote like parts and in which:

FIG. 1 is a front perspective view of a walking frame apparatus embodying an aspect of the invention showing a user located thereon;

FIG. 2 is a side view of the walking frame apparatus;

FIG. 3 is a top plan view of the walking frame apparatus;

FIG. 4 front view of the walking frame apparatus;

FIG. 5 is a front perspective view of the walking frame apparatus, in particular showing a pedal apparatus with a user supported thereon;

FIG. 6 is a side perspective view of a second embodiment of the walking frame apparatus;

FIG. 7 is a front plan view of the second embodiment of the walking frame apparatus;

FIG. 8 is a side plan view of the second embodiment of the walking frame apparatus;

FIG. 9 is a side plan view of the second embodiment of the walking frame apparatus showing in particular the movement of the pedal apparatus

FIG. 10 is a top plan view of the second embodiment of the walking frame apparatus; and;

FIG. 11 is a perspective view of the second embodiment of the walking frame apparatus, in particular showing a user supported thereon;

FIG. 12 is a side plan view of an alternative embodiment of the pedal apparatus;

FIG. 13 is a front perspective view of the pedal apparatus of FIG. 12;

FIG. 14 is a top perspective view of the pedal apparatus of FIG. 12; and

FIG. 15 is a side plan view of the pedal apparatus of FIG. 14.

### DETAILED DESCRIPTION

Referring to the drawings, there is shown generally indicated by the reference numeral 1, a walking frame apparatus embodying an aspect of the invention. It should be understood that the term “vertical” is intended to mean the axis which extends perpendicular to the ground surface upon which the walking frame 1 rests in-use. Additionally the term “upward” should be understood as intending to mean the direction which is opposite to the direction of the ground surface upon which the apparatus 1 rests in-use. The walking frame apparatus 1 comprises a frame 3 for supporting a user in an upright position. To this end, the frame 3 has at least one ground-engaging portion 5, the ground engaging portion 5 of the frame 3 is adapted for moving engagement with the ground upon which the apparatus 1 rests in-use. In preferred embodiments therefore, the apparatus 1 is a self-propelled structure which is movable at least in fore and aft directions however in alternative embodiments a secondary user may propel the apparatus 1 and further alternatively a motor or other suitable mechanism may be provided such as to propel the apparatus 1. A pedal apparatus 7 is coupled to the frame 3 with which the user may propel the apparatus 1. The frame 3 is configured to support a user in an upright position (e.g., standing or walking) and to this end the frame is shaped and dimensioned to define a station for receiving and accommodating the user in the upright position. The pedal apparatus 7 is located upon the frame 3 for use by a user in the upright position and to this end the pedal apparatus 7 is typically located upon or adjacent to the bottom of the frame 3.

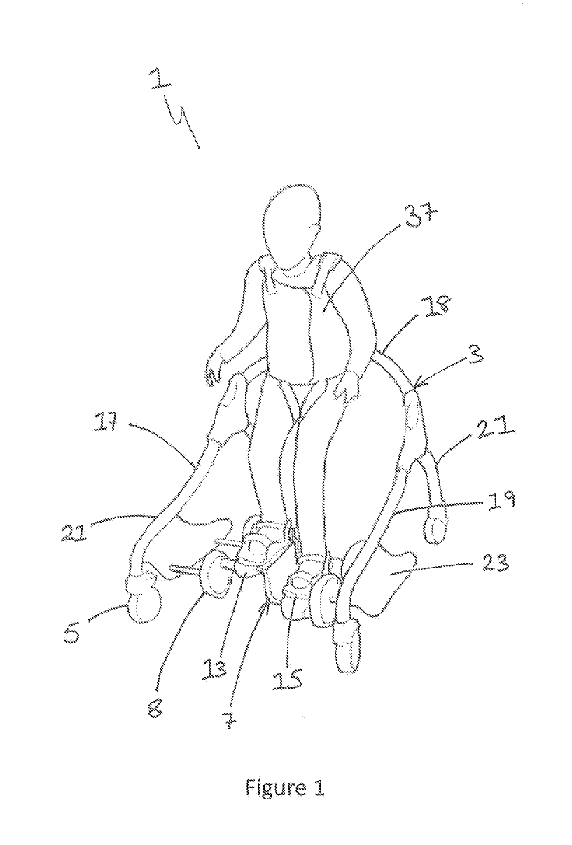

The frame 3 typically comprises at least first and second spaced apart sides 17, 19 which are preferably coupled by at least one cross member 18 which extends transversely between the first and second sides 17, 19. The first and second sides 17, 19 typically extend substantially parallel relative to one another whilst the cross member 18 extends perpendicular there between. The sides 17, 19 and the cross member 18 may comprise a plurality of sections which are coupleable together; for example these sections may be pivotably coupled together such as to allow the frame 3 of the walking frame apparatus 1 to be foldable/collapsible in-use. In a preferred embodiment the first and second sides 17, 19 and cross member 18 may be made from a single piece and/or otherwise rigidly fixed together. An elongate channel is typically defined between the first and second sides 17, 19 of the frame 3, the channel being shaped and dimensioned to accommodate at least one user. In a preferred embodiment, a respective front and rear channel are defined in front of and behind, respectively, the cross member 18, each channel being shaped and dimensioned to accommodate a respective user. The cross member 18, or at least part of it, is positioned for connection to a respective user in the, or each, adjacent channel. Advantageously, the or each elongate channel is open-ended to allow for easy entry and exit for the user. Alternatively, an end member (not shown) may extend between the first and second sides 17, 19 at one end only, such as to define an open-ended substantially square or rectangular base. With reference in particular to FIG. 1, the user in need of walking assistance is accommodated by the front channel, preferably the user will self-propel the walking frame apparatus 1 whilst they are located therein however at times they may need additional assistance and to this end a secondary user (not shown) may be accommodated by the rear channel. The cross member 18 is readily available as a hand hold for the secondary user to displace the apparatus 1 whilst they are disposed within or adjacent the rear channel. Advantageously the frame 3 is shaped such that when the user is disposed in the front channel they are within arms reach of the first and second sides 17, 19 of the frame 3.

Each of the first and second sides 17, 19 of the frame 3 has a ground engaging portion 5, which may comprise one or more wheels or rollers or slides or any other suitable displaceable ground engaging member. The first and second sides 17, 19 of the frame 3 typically comprise a plurality of legs 21. Preferably each of the first and second sides 17, 19 comprise a pair of legs 21 which extend from opposite ends of the cross member 18 in a bidirectional arrangement such that one of the legs 21 extends in a forward direction and the other in a rearward direction. Forward direction is to be understood as the direction in which the user faces, moves, when coupled to the walking support apparatus 1 in-use with the rearward direction being the opposite direction. The legs 21 are typically substantially arcuate or bow-shaped however they may alternatively comprise any other suitable shape. Preferably the legs 21 extending in the forward direction are longer than those that extend in the rear direction. The ground engaging portions 5 of the first and second sides 17, 19 are typically provided upon the distal ends of the legs 21, see for example FIG. 1 where a plurality of wheels are located upon the distal ends of the legs 21.

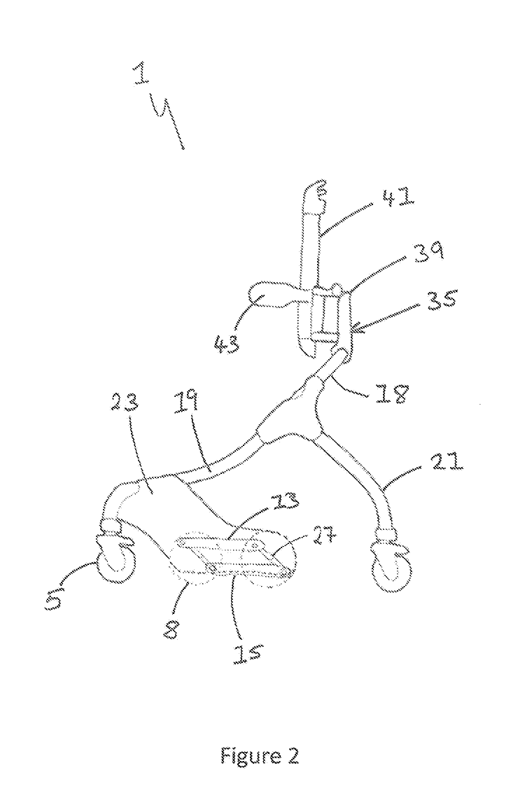

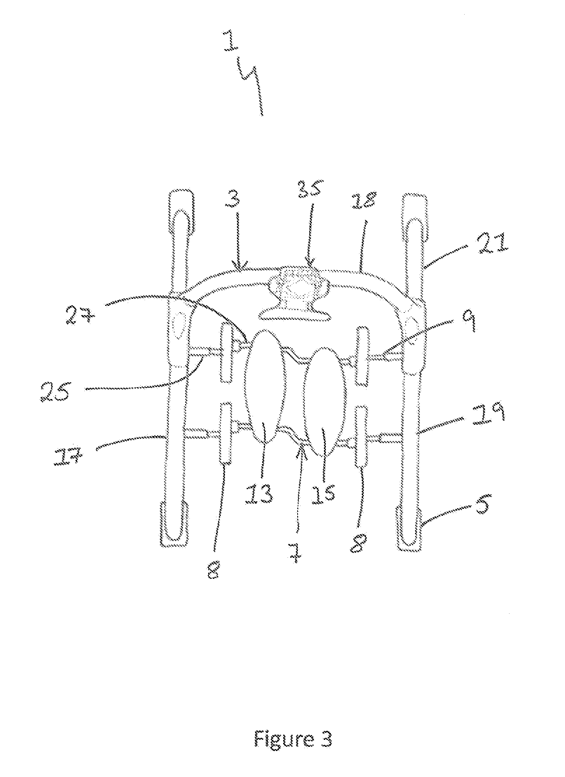

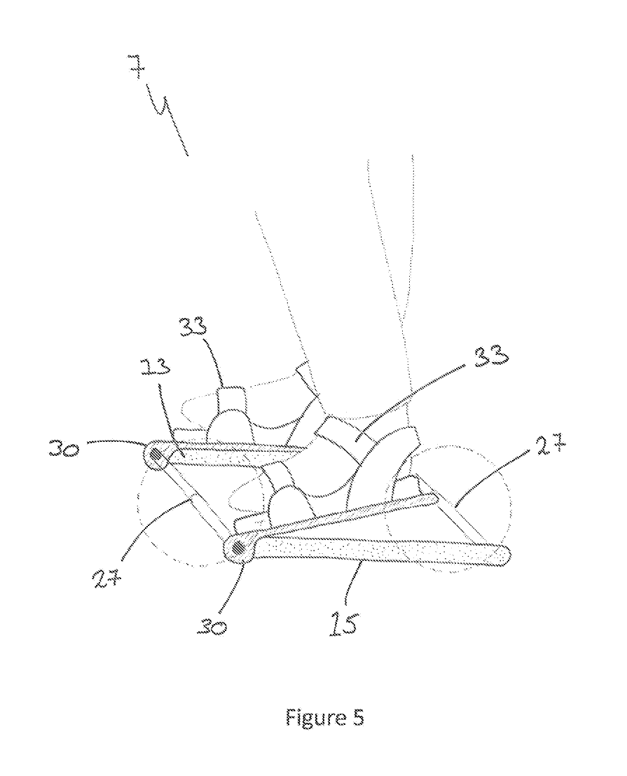

The pedal apparatus 7 is typically removably coupled to the frame 3. In the first embodiment, as shown in FIGS. 1 to 5 the pedal apparatus 7 is typically coupled to each of the first and second sides 17, 19 such that it extends between the first and second sides 17, 19. To this end the pedal apparatus 7 extends substantially parallel to the cross member 18, perpendicular to the first and second sides 17, 19. In a preferred embodiment as shown in FIGS. 1 and 2 the pedal apparatus 7 is coupled to wings 23 which extend from the first and second sides 17, 19 of the frame 3. The wings 23 typically extend substantially parallel to the first and second sides 17, 19. In a preferred embodiment the wings 23 are coupled to the legs 21, more preferably the legs 21 which extend from the cross member 18 in the forward direction as shown in FIG. 1. The wings 23 extend from the distal end region of the forward legs 21 in the rearward direction such as to extend, at least in part, alongside the front channel. Alternatively, the wings 23 may extend between the opposing front and rear legs 21 of each of the first and second sides 17, 19. In an alternative embodiment the frame 3 may incorporate a central portion (not shown) which extends towards the ground from the cross member 18 and/or the sides 17, 19 upon which the pedal apparatus 7 may be coupled.

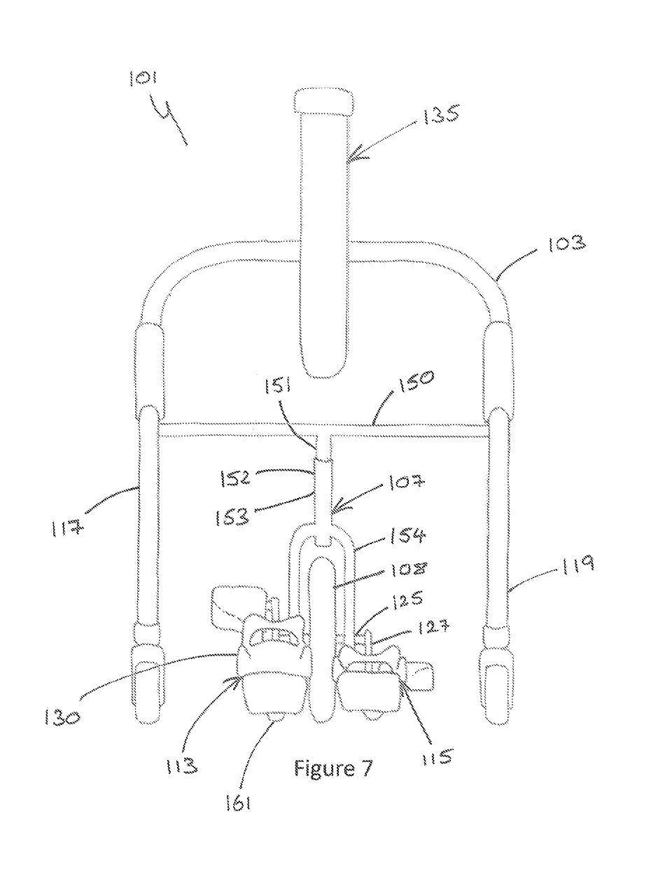

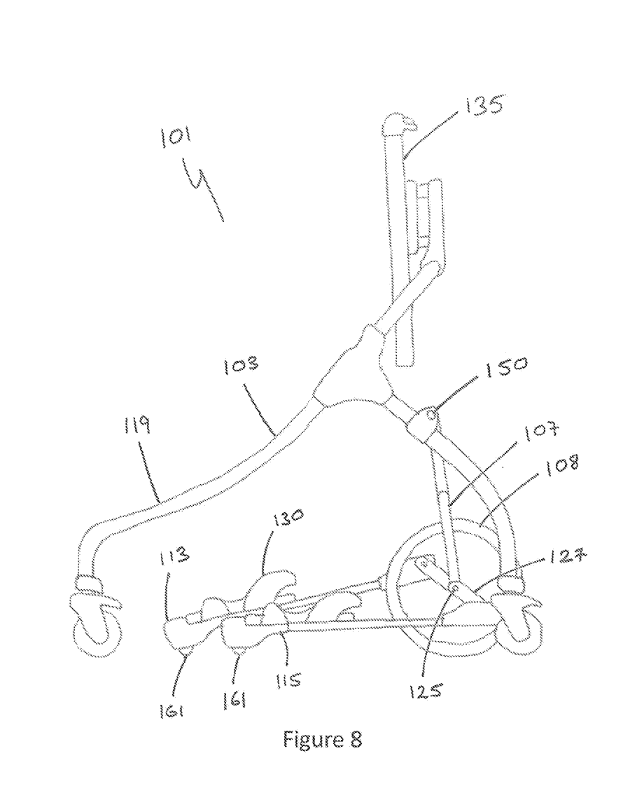

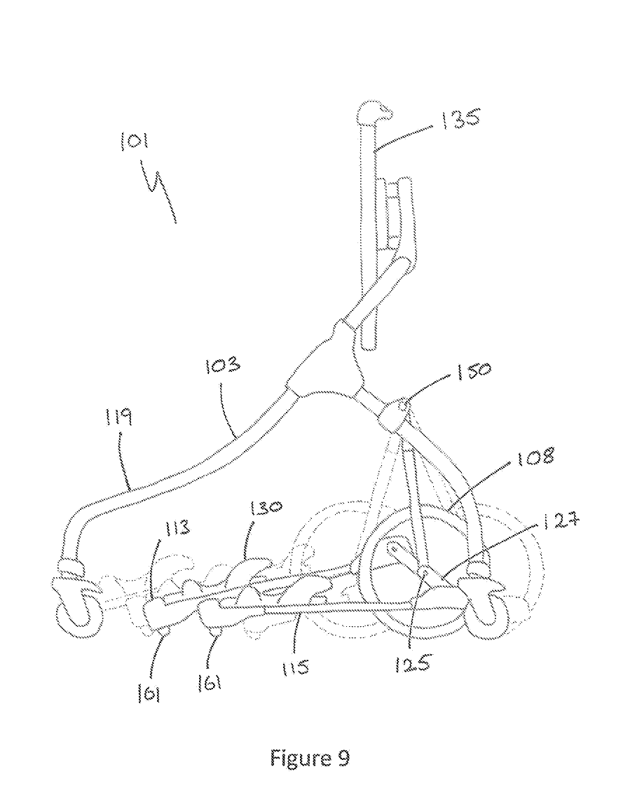

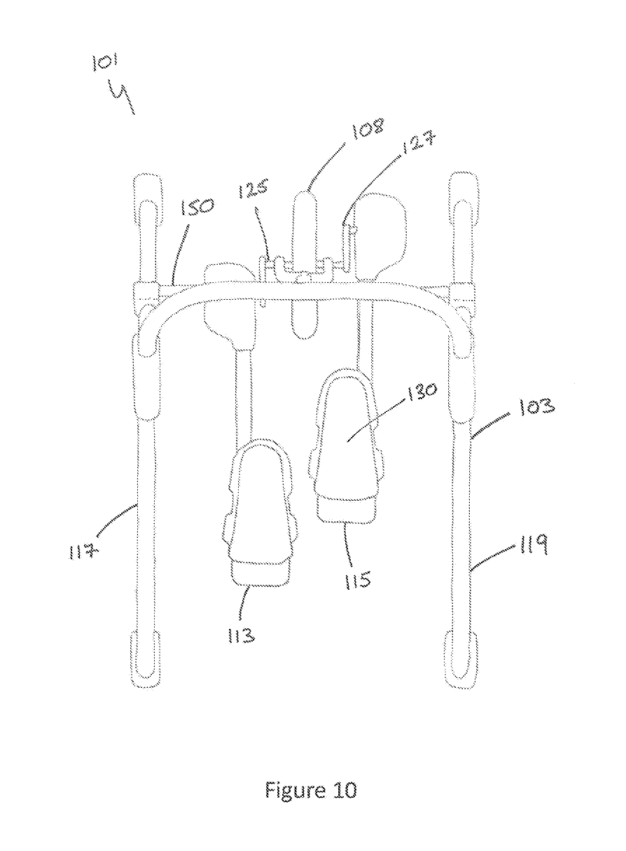

The pedal apparatus 7 comprises an axle assembly 9 which comprises at least one ground engaging wheel 8 and first and second pedals 13, 15 which are coupled to the axle assembly 9. The pedal apparatus 7 is configured to translate acentric motion of the pedals 13, 15 into rotational movement of the at least one ground engaging wheel 8. The pedals 13, 15 are capable of driving or of being driven by the at least one ground engaging wheel 8. The ground engaging portion 5 of the frame 3 is at the substantially same level as the wheel(s) of the pedal apparatus 7 so that they can engage the ground simultaneously. The axle assembly 9 extends transverse to the forward and rear direction of the apparatus 1 in-use such that the rotational movement of the at least one ground engaging wheel 8 causes displacement of the apparatus 1 in the forward or rear directions in-use. The at least one ground engaging wheel 8 is coupled to at least one axle shaft 25. The ground engaging wheel 8 typically comprises a wheel, as shown in FIGS. 1 to 11 however the ground engaging wheel 8 may alternatively comprise one or more rollers or slides or any other suitable displaceable ground engaging member. The at least one ground engaging wheel 8 is rotatable about a central axis that is perpendicular to the forward and rear directions.

The first and second pedals 13, 15 are coupled to the at least one axle shaft 25 by at least one linkage 27. The at least one linkage 27 is configured to translate linear motion into rotational motion and to this end the linkage may comprise a crank or member or any other suitable linkage. In the first embodiment the linkage 27, typically comprises a crank, comprising first and second elongate portions 28 which are joined by an angled portion 29, the angled portion 29 typically extends substantially perpendicular to both the first and second elongate portions 28. Typically the first and second pedals 13, 15 are removably coupled upon the linkage 27 and to this end the pedals 13, 15 may incorporate a coupling assembly (not shown) or alternatively the pedals 13, 15 may comprise two or more separable parts which may be coupled together, typically whilst the separable parts are positioned, at least in part, upon the linkage 27. Preferably, the pedals 13, 15 are shaped and dimensioned to incorporate an aperture through which the linkage 27 may extend and rotate. The linkage 27 is configured such that each of the pedals 13, 15 are coupled to the axle shaft 25 acentric or offset to the central axis defined by the ground engaging wheel 8 more particularly to the axle shaft 125 which extends through the wheel 8, with the pedals 13, 15 being arranged upon the linkage 27 such that they are located upon diametrically opposed sides of the central axis defined by the at least one ground engaging wheel 8 such that when one pedal 15 is at its lowest point the other pedal 13 is at its highest. To this end the pedals 13, 15 are coupled upon the linkage 27 such that when the angled portion 29 of the linkage 27 is rotated such that it extends perpendicular to the ground, one of the pedals 13 is located substantially above the other 15 with the pedals 13, 15 being substantially aligned on the same vertical plane. Additionally where the angled portion 29 of the linkage 27 is rotated such that it extends parallel to the ground, one of the pedals 13 is located further forward than the other and both pedals 13, 15 are aligned on the same horizontal plane. When the wheel(s) 8 rotates, the pedals 13, 15 follow the rotational pattern defined by the acentric or offset coupling to the axle shaft 25 whilst remaining at opposing sides of the central axis. Preferably the rotational pattern defined by the acentric coupling to the axle shaft 25 is an orbital pattern. Preferably the rotational pattern defined by the acentric coupling to the axle shaft 25 is substantially circular.

In the first embodiment shown in FIGS. 1 to 5, the axle shaft 25 is typically coupled to each of the first and second sides 17, 19 of the frame 3. In this embodiment, the axle assembly 9 has first and second spaced apart axle shafts 25 with both of the first and second pedals 13 and 15 being coupled to both of the axle shafts 25. Furthermore first and second wheels 8 are typically mounted on the, or each, axle shaft 25, with the first and second pedals 13, 15 being located between the first and second wheels 8 such that there are at least four wheels coupled to the axle assembly 9 as shown in FIGS. 1 to 4.

In an alternative embodiment (not shown) the axle assembly 9 may comprise a single ground engaging wheel 8 which is typically located between the first and second sides 17, 19 of the frame 3 with the first and second pedals 13, 15 being located upon either side of the ground engaging wheel 8. In this embodiment the first and second pedals 13, 15 may be coupled to the first and second sides 17, 19 by an additional linkage 27 or an orbital coupling or any other suitable coupling arrangement.

The first and second pedals 13, 15 may be shaped and dimensioned such as to accommodate the users' feet. The pedals 13, 15 may additionally comprise one or more straps 33 or other securing assembly which are operable to secure the users foot within the pedal 13, 15. Advantageously the straps 33 may hold the users feet securely in place and may enable users, particularly children, who lack experience of normal hip and knee extension to achieve optimum movement. The straps 33 may be opened to prevent pulling the pedal 13, 15 up by using hip and knee flexion (bending). This allows more able users to utilise active hip and knee extension in a pushing down action involving movement towards a standing and stepping action. However in alternative embodiments the pedals 13, 15 may incorporate a latch or other coupling formation (not shown) which may be configured to couple the users shoe or other footwear to the pedals 13, 15. In a preferred embodiment a footplate 30 is coupled upon each of the pedals 13, 15. The footplate 30 is shaped and dimensioned such as to accommodate the users' foot, additionally the footplate 30 may comprise one or more straps 33 or other securing assembly which are operable to secure the users foot upon the footplate 30. The footplate 30 as shown in FIGS. 1 to 5 is preferably configured to pivot such that at least a portion of the footplate 30, typically the rear portion, may lift relative to the pedal 13, 15 whilst still being coupled to the pedal 13, 15 and to this end the footplate 30 is typically pivotably coupled upon the pedal 13, 15 upon at least one location. The footplate 30 is typically pivotably coupled to the pedals 13, 15 at a forward location upon the pedal 13, 15, to this end the footplate 30 is preferably coupled at the in-use toe portion of the footplate 30 to the pedal 13, 15. Advantageously this allows the user to lift their heel whilst they are coupled to the apparatus 1 such that they can affect a more natural walking gait in-use. Alternatively the footplate 30 may be pivotably coupled to the pedals 13, 15 at a rearward location upon the pedal 13, 15, to this end the footplate 30 is ideally coupled to the pedal 13, 15 at the in-use heel portion of the footplate 30. The footplate 30 is typically pivotably coupled to the pedals 13, 15 by a hinge 33 or any other suitable pivotable coupling.

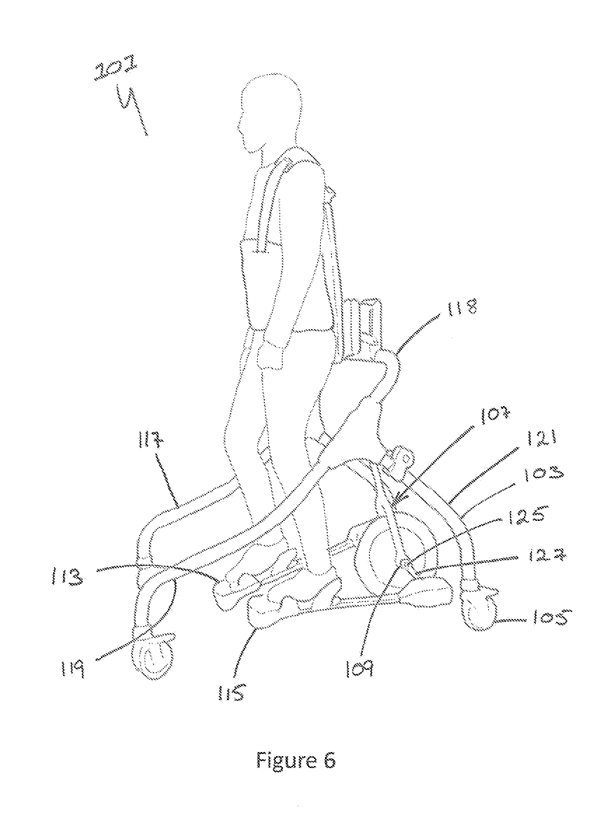

In the second embodiment, shown in FIGS. 6 to 11, the pedal apparatus 107 is typically coupled to the frame 103 by a transverse member 150. The transverse member 150 typically comprises an elongate member which extends transversely between the first and second sides 117, 119 of the frame 103 such that it extends perpendicular to the first and second sides 117, 119. Preferably the transverse member 150 extends between the opposing legs 121, of the first and second sides 117, 119, which extend in the rearward direction. The transverse member 150 further comprises a central portion 151, which extends substantially parallel to the vertical axis, towards the ground surface upon which the apparatus 101 rests in-use. The pedal apparatus 107 is coupled, typically pivotably so, to the transverse member 150, in particular to the central portion 151 of the transverse member 150 such that the pedal apparatus is disposed towards the rear of the walking frame apparatus. Alternatively the transverse member 150 is coupled to the first and second sides 117, 119 such that it is configured to rotate relative to the first and second sides 117, 119. To this end the central portion 151 and/or pedal apparatus 107 may be arranged upon the transverse member 150 such that they can rotate about it also.

The pedal apparatus 107 comprises a support structure 152 which is configured to support at least a single ground engaging wheel 108. The support structure 152 is typically substantially Y shaped, having a body section 153 and two leg sections 154 which are shaped and dimensioned such as to receive the axle assembly 109, including the ground engaging wheel 108 therebetween. The support structure 152 is typically pivotably coupled to the transverse member 150 at one end and the axle assembly 109 at the opposing end. The single ground engaging wheel 108 is located between the first and second sides 117,119 of the frame 103 with the first and second pedals 113, 115 being located upon either side of the ground engaging wheel 108. The first and second pedals 113, 115 are each coupled to the axle shaft 125 by respective linkages 127. The linkages 127 each comprise an elongate member which is pivotably coupled to the axle shaft 125 at one end and the first or second pedal 113, 115 at the opposing end.

The linkages 127 are configured such that each of the pedals 113, 115 are coupled to the axle shaft 125 acentric to the central axis defined by the ground engaging wheel 108 with the pedals 113, 115 being arranged upon the linkages 127 such that they are located upon diametrically opposed sides of the central axis defined by the at least one ground engaging wheel 108 such that when one pedal, for example, the second pedal 115 is at its lowest position the other pedal 113 is at its highest position with both pedals being on the same vertical axis, and/or, where the second pedal 115 is at its furthest forward position, the first pedal 113 is located at its furthest rearward position with both pedals being on the same horizontal axis. When the wheel(s) 108 rotates, the pedals 113, 115 follow the rotational pattern defined by the acentric coupling to the axle shaft 125 whilst remaining at opposing sides of the central axis. Preferably the rotational pattern defined by the acentric or offset coupling to the axle shaft 125 is an orbital pattern, in particular a substantially elliptical pattern.

As shown in FIGS. 6 to 11, the first and second pedals 113, 115 comprise elongate members 160 which are coupled to the axle shaft 125 by the respective linkages 127 at one end, towards the rear of the apparatus 101, and at the opposing end have respective footplates 130 provided thereon, towards the front of the apparatus 101. The pedals 113, 115 may comprise one or more weights (not shown). The first and second pedals 113, 115 additionally comprise a ground engageable section 161 comprising a ball caster or roller or wheel or any other suitable apparatus, which is configured to contact, displace along the ground. The ground engageable section 161 is located upon the underside of the pedals 113, 115, typically towards the front end of the pedals 113, 115. The length of the pedals 113, 115 may vary however they are typically arranged such as to allow a minimal force to be required to affect rotational movement.

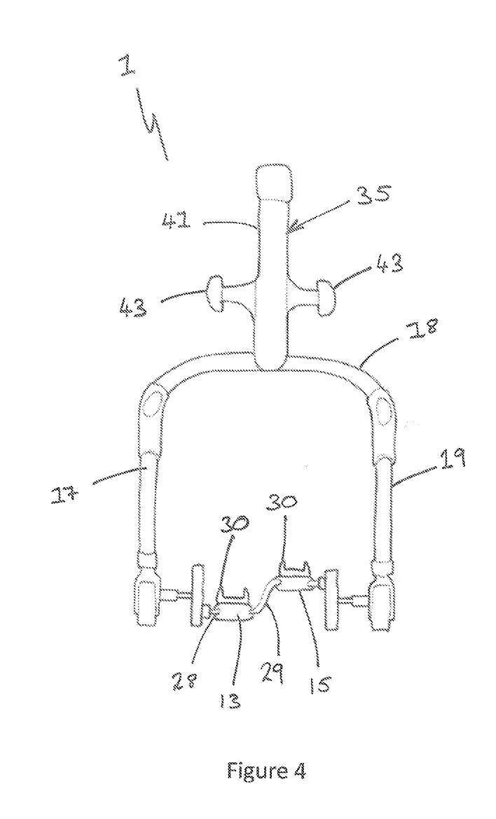

Preferably, the user is coupled to the frame 3, 103 of the walking frame apparatus 1, 101. To this end, a bracket 35, 135 may be removably coupled to the frame 3, 103 the bracket 35, 135 comprising a coupling assembly (not shown) configured to couple the user thereon. The bracket 35, 135 and/or the coupling assembly thereof may be co-operable with a harness 37, 137 such as to releasably couple the user upon the frame 3, 103. The bracket 35, 135 is typically coupled to the cross member 18, 118 of the frame 3, 103, ideally centrally upon the cross member 18, 118. The bracket 35, 135 typically extends, at least in part, into the front channel defined by the first and second sides 17, 117, 19, 119 and the cross member 18, 118 such that the user may be coupled within the front channel. The bracket 35, 135, as shown in FIG. 4, typically comprises a base portion 39, 139 which is coupled to the frame 3, 103. A central portion 41, 141 is coupled, at least in part, to the base portion 39, 139, typically via a rail arrangement (not shown) or any other suitable coupling arrangement which is configured to allow the central portion 41, 141 to slide or otherwise displace relative to the base portion 39, 139 such that the central portion 41, 141 may assume a plurality of extended or retracted positions, with the central portion being lockable in any one of said plurality of positions. Advantageously the coupling arrangement between the central portion 41, 141, base portion 39, 139 allows the central portion 41, 141 to be positioned at a plurality of different heights relative to the base portion 39, 139 such that the apparatus 1, 101 may accommodate users of varying height. The central portion 41, 141 may also comprise one or more projections 43, 143, which typically extend from either side of the central portion 41, 141 substantially parallel to the cross member 18, 118, however alternatively they may extend substantially parallel to the first and second sides 17, 117, 19, 119 further alternatively the projections may be pivotably coupled upon the central portion 41, 141 such that they may vary between either of the positions described previously. At least part of the coupling assembly suitable for coupling the user to the bracket 35, 135 may be provided upon the projections 43, 143. Optionally a shelf or seat (not shown) may be removably coupled to the frame 3, 103 typically to the cross member 18, 118 and/or the bracket 15, 115.

In-use, in the first embodiment the user may be coupled to the frame 3 of the apparatus 1, typically by a co-operable engagement between the coupling assembly provided on the bracket 35 and the harness 37 worn by the user as shown in FIG. 1. Advantageously, this arrangement is configured to secure the user in the upright position in-use. The pedal apparatus 7 may then be removably coupled upon the frame 3 or the pedal apparatus may already be provided thereon. The user may then place their feet into or upon the footplates 30 provided upon the pedals 13, 15. Optionally the users' feet may be secured within the footplates by the straps 33. With the user secured within the apparatus 1 they may then affect rotational motion of the respective pedals 13, 15 by applying a downward and/or upward force to either pedal 13, 15 in an alternating fashion such that the at least one ground engaging wheel 8 rotates and because the at least one ground engaging portion 5 of the frame 3 is provided upon the same level as that of the pedal apparatus 7, movement of the at least one ground engaging wheel 8 will affect movement of the at least one ground engaging portion 5 of the frame 3 simultaneously thereby enabling movement of the apparatus 1 in-use.

In-use, in the second embodiment the user may be coupled to the frame 103 of the apparatus 101, typically by a co-operable engagement between the coupling assembly provided on the bracket 135 and the harness 137 worn by the user as shown in FIG. 6. Advantageously, this arrangement is configured to secure the user in the upright position in-use. The pedal apparatus 107 may then be removably coupled upon the frame 103 or the pedal apparatus may already be provided thereon. The user may then place their feet into or upon the footplates 130 provided upon the pedals 113, 115. Optionally the users' feet may be secured within the footplates by the straps. With the user secured within the apparatus 1011 they may apply a downward and/or upward force to either pedal 113, 115 in an alternating fashion. As the pedals 113, 115 are being alternatively moved; the front end portions of the pedals 113, 115, and more specifically the ground engageable section 161 of each pedal 113, 115, are also contacting the ground in an alternating fashion i.e. one pedal is in contact with the ground at any one time. Further additionally the offset or acentric pivoting coupling of the pedals 113, 115 to the axle shaft 125 is configured to cause the pedals 113, 115 to rotate about the central axis defined by the ground engaging wheel 108 such as to establish a reciprocating motion of the pedals 113, 115. The pedals 113, 115, more specifically the forward end of the pedals 113, 115 upon which the footplates 130 are disposed are operable to rotate in an orbital pattern such as a substantially elliptical pattern about the central axis. This results in the ground engaging wheel 108 rotating simultaneously with the ground engaging portions 105 of the frame 103 such as to enable movement of the apparatus 101 in-use. Advantageously, the reciprocal movement of the pedals 113, 115 aid the user in making the required movements, which is particularly useful when the user has limited leg motion.

Alternatively a secondary user, may position themselves in-use within the rear channel defined by the frame 3, 103 and then may push or pull the walking frame apparatus 1, 101 such that the ground engaging wheels 8, 108 of the pedal apparatus 7, 107 rotate, and thus reciprocally cause the pedals 13, 113, 15, 115 to move in the rotational pattern. Accordingly the pedals 13, 113, 15, 115 would then force the user's feet to move in the same pattern concurrently in-use. Further alternatively a motor such as an electric motor or other suitable mechanism coupled upon the apparatus 1, 101 may be configured to cause rotational movement of the ground engaging wheel 8, 108 such that the pedals 13, 113, 15, 115 and consequently the users' feet are displaced in the rotational pattern in-use. Advantageously, the walking frame apparatus 1, 101 prevents atypical walking patterns whilst also fixing the users feet, hips and knees in a good alignment such that muscle activity achieved using the apparatus 1, 101 may reduce the risk of muscle shortening by guiding the user to actively flex and extend their hips and knees. Furthermore the increased distance achieved using the apparatus 1, 101, may improve bone strength with reduced risk of lower limb fracture and associated debility and discomfort.

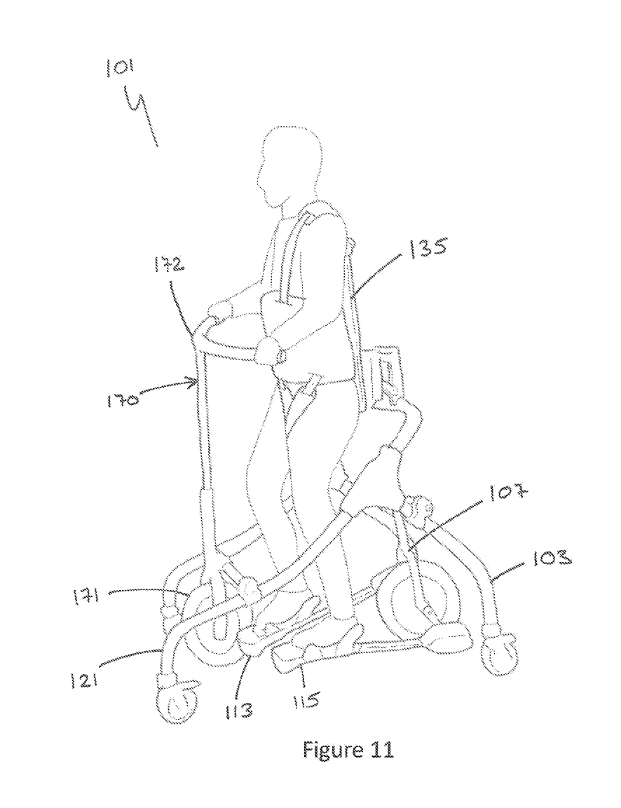

In an alternative embodiment the walking frame apparatus 1, 101 preferably comprises a steering arrangement 170 configured to provide an assembly of steering the apparatus 1 to the user as shown in FIG. 11. The steering arrangement 170 is supported on the frame 103 of the apparatus 101, typically upon the first and second sides 117, 119 thereof. The steering arrangement 170 is preferably removably coupled to the frame 103. To this end the steering arrangement 170 is disposed between the first and second sides 117, 119, preferably between the opposing legs 121, of the first and second sides 117, 119, which extend in the forward direction. Advantageously, this assembly that in-use the steering arrangement 170 is located in front of the user coupled to the apparatus 101, providing them with assembly of steering the apparatus 101 without the need of a secondary user. The steering arrangement 170 typically comprises at least one ground engaging wheel 171 and a handle portion 172, the handle portion being shaped and dimensioned to receive and retain the ground engaging wheel 171 upon an axle at one end and being shaped and dimensioned at the opposing end to provide grip locations for the user.

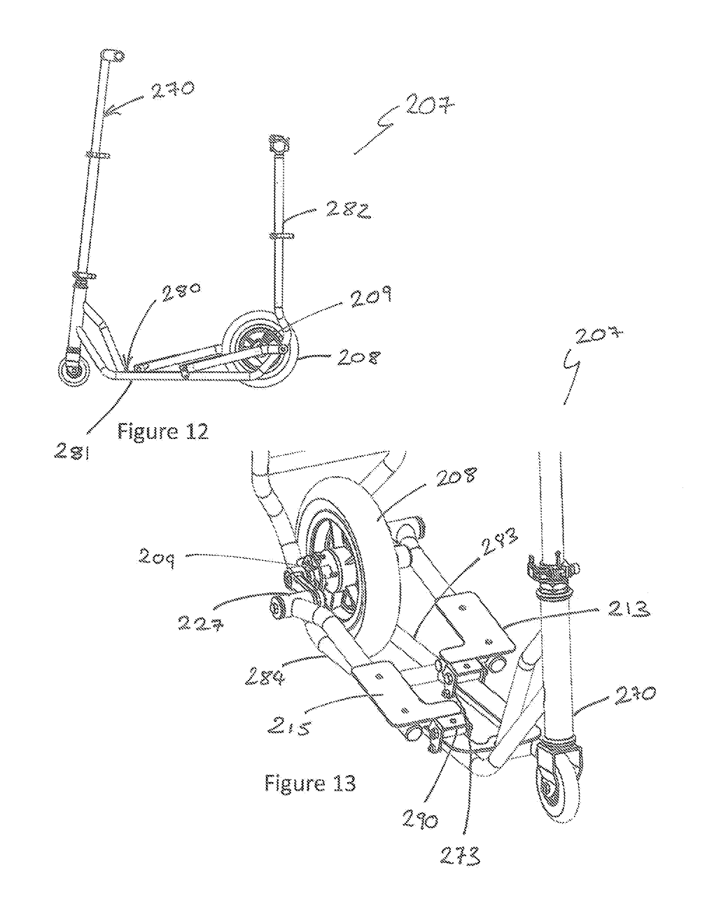

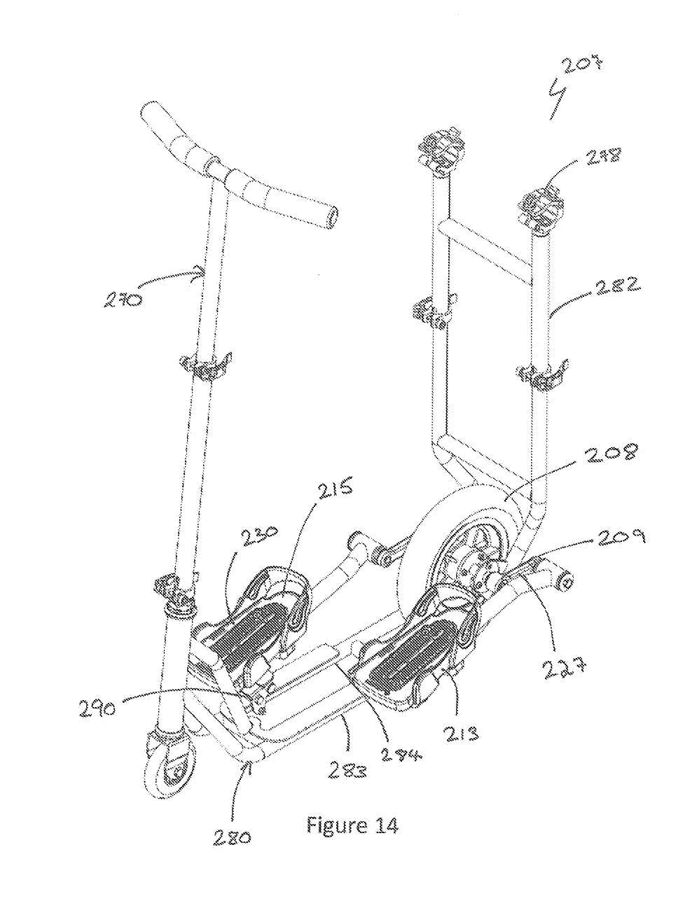

An alternative embodiment of the pedal apparatus 207 is shown in FIGS. 12 to 15. The pedal apparatus 207 may be removably coupled to the frame 3, 103, typically at or towards the cross member 18, 118. To this end the pedal apparatus 207 comprises one or more fastening arrangements 278 for coupling the pedal apparatus 207 to the frame 3, 103. The pedal apparatus 207 comprises a frame assembly 280, the axle assembly 209 and preferably the steering arrangement 270 which may be integrally formed with the frame assembly 280 as is shown in FIGS. 12 to 15, or alternatively removably coupled to the frame assembly 280. The frame assembly 280 typically comprises at least a base portion 281 and a rear portion 282, wherein the base portion 281 extends substantially parallel to the ground surface upon which the pedal apparatus 207 rests in-use and the rear portion 282 extends substantially perpendicular relative to the base portion 281. The base portion 281 preferably comprises spaced apart first and second members 283, 284, which are ideally elongate in shape, which define a channel between one another within which the ground engaging wheel 208 of the axle assembly 209 may be located, typically at or towards the rear portion 282, wherein the ground engaging wheel 208 may rotate therein in-use. The base portion 281 may also comprise one or more cross members 285 which extend transverse the channel between the spaced apart first and second members 283, 284. The base portion 281, ideally the spaced apart first and second side members 283, 284 thereof, may be shaped and dimensioned such that at least one end extends in a substantially perpendicular direction relative to the remainder of the base portion 281 such as to form the rear portion 282 of the frame assembly 280, wherein the steering arrangement 270 may be coupled to or formed at the opposing end of the base portion 281. Alternatively the rear portion 282 may be a separate portion which may be removably coupled to the base portion 281. The rear portion 282 typically extends to a height such that it may be coupled to the frame 3, 103, typically to a cross member thereof. The rear portion 282 may also comprise first and second spaced apart members, may additionally include one or more cross members which extend therebetween as shown in FIG. 14.

The axle assembly 209 comprising a single ground engaging wheel 208 is preferably coupled to the base portion 281 and/or rear portion 282. The first and second pedals 213, 215 are located upon either side of the ground engaging wheel 208. The first and second pedals 213, 215 are each coupled to the axle shaft 225 by respective linkages 227. The linkages 227 each comprise an elongate member which is pivotably coupled to the axle shaft 225 at one end and the first or second pedal 213, 215 at the opposing end.

The linkages 227 are configured such that each of the pedals 213, 215 are coupled to the axle shaft 225 acentric to the central axis defined by the ground engaging wheel 208 with the pedals 213, 215 being arranged upon the linkages 227. The offset or acentric pivoting coupling of the pedals 213, 215 to the axle shaft 225 is configured to cause the pedals 213, 215 to rotate about the central axis defined by the ground engaging wheel 208 such as to establish a reciprocating motion of the pedals 213, 215. To this end when the wheel 208 rotates, the pedals 213, 215 follow the rotational pattern defined by the acentric coupling to the axle shaft 225 whilst remaining at opposing sides of the central axis. It should be noted that the pedals 213, 215 extend in the forward direction which extends perpendicular to the central axis defined by the axle shaft 225. Preferably the rotational pattern defined by the acentric or offset coupling to the axle shaft 225 is an orbital pattern, in particular a substantially elliptical pattern.

In this embodiment of the pedal apparatus 207, the pedals 213, 215 are arranged to movably engage with the base portion 281 by respective displacement assembly 290. Preferably the pedals are movably coupled to the base portion 281, ideally at a forward end of the pedals 213, 215. Typically the first pedal 213 is coupled to one of the spaced apart members 283 with the second pedal 215 being coupled to the other one of the spaced apart members 283. To this end the pedals 213, 215 are ideally coupled to the base portion 281 by the respective displacement assembly 290. The displacement assembly 290 may comprise a roller or ball the like. The displacement assembly 290 is configured to allow the pedals 213, 215 to displace, in a linear—forward, backward fashion, along the at least a portion of the base portion 281 such as to affect reciprocal rotational displacement of the axle shaft 225, ground engaging wheel 208. The displacement assembly 290 is typically arranged such as to displace along the upward face of the spaced apart members 283, 284.

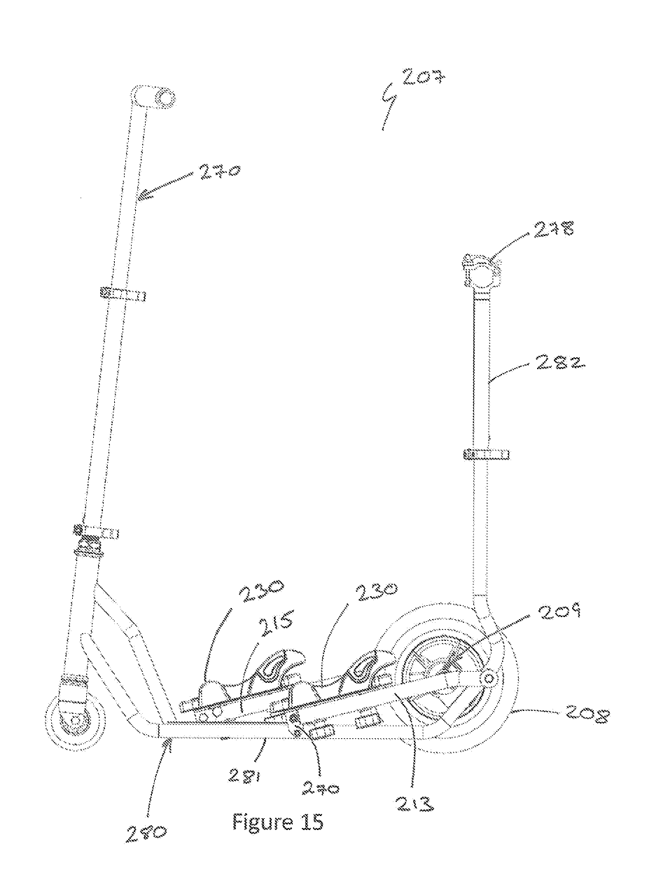

Advantageously this means that the surface against which the pedals 213, 215 displace is constant, and the user will not have to consider uneven ground surfaces or different materials of ground surface upon which the apparatus may traverse in-use. The displacement assembly 270 may each further comprise a stopper 273 which is configured to prevent the pedals 213, 215 from being lifted upwards and away from the base portion 281 in-use. Advantageously this prevents the pedals 213, 215 from being lifted away from the base portion 281 such that the user can't move their feet or legs into undesired positions. To this end the stopper 273 may comprise a portion which is coupled to or integrally formed with the displacement assembly 290 is shaped to engage the underside of the base portion 281, typically the respective undersides of the first and second spaced apart members 283, 284. The undersides of the first and second spaced apart members 283, 284 being the side which faces towards the ground surface in-use, with the upper face being that which faces in the opposing direction. Alternatively the stopper 273 may comprise any suitable latch or catch arrangement which is operable to prevent removal of the pedals 213, 215 from the base portion 281. The extent to which the pedals may 213, 215 displace along the base portion 281 is determined by the length of the linkages 227 coupling the pedals 213, 215 to the axle shaft 225. The pedals 213, 215 preferably comprise the footplates 230 which can be seen in FIGS. 14 and 15 which may optionally include the straps 233 for securing the user's feet therein in-use.

The steering arrangement 270 preferably comprises a caster which displaces upon the ground surface upon which the apparatus rests-use at one end and a handle arrangement at the opposing end. The ground engaging wheel 208 of the pedal assembly is preferably larger than the caster of the steering arrangement 270. It is preferred that the frame assembly 280 and/or the steering arrangement 270 comprise a plurality of collapsible parts such that the pedal apparatus 207 may be collapsible/foldable in-use however alternatively the frame assembly 280 and/or the steering arrangement 270 may comprise non collapsible or foldable parts.

The invention is not limited to the embodiment(s) described herein but can be amended or modified without departing from the scope of the present invention.

What is claimed is:

1. A walking frame apparatus comprising:
a frame for supporting a user in a walking position, the frame having at least one ground-engaging portion; and
a pedal apparatus coupled to the frame, the pedal apparatus comprising:
an axle assembly comprising at least one ground-engaging wheel; and
first and second pedals coupled to the axle assembly.

2. The walking frame apparatus of claim 1, wherein the pedal apparatus is removably coupled to the frame; and/or wherein the frame has first and second spaced apart sides, the pedal apparatus being located between said first and second sides; and/or wherein each of said first and second sides of the frame has a ground-engaging portion comprising one or more wheels, rollers or slides.

3. The walking frame apparatus of claim 1, wherein said at least one ground-engaging wheel is coupled to at least one axle shaft; and/or wherein said first and second pedals are coupled to said at least one axle shaft by at least one linkage; and/or wherein said linkage is configured to translate linear motion into rotational motion, the linkage preferably comprising a crank or pivoting member or any other suitable linkage.

4. The walking frame apparatus of claim 1, wherein each of said pedals comprise a footplate which is shaped and dimensioned to accommodate each of the users feet; and/or wherein each of said footplates are pivotably coupled, preferably at one end, to respective pedals; and/or wherein said footplates may comprise a strap which is configured to secure the users foot therein.

5. The walking frame apparatus as claimed in claim 2, wherein the pedal apparatus is coupled to each of said first and second sides and extends between said first and second sides; and/or wherein said at least one axle shaft is coupled to each of said first and second sides of the frame; and/or wherein said axle assembly has first and second spaced apart axle shafts, both of said first and second pedals being coupled to both of said axle shafts; and/or wherein first and second wheels are mounted on each, axle shaft; and/or wherein first and second pedals are located between said first and second wheels.

6. The walking frame apparatus of claim 5 wherein the respective first and second pedals are coupled to said first and second axle shafts by respective linkages, the linkages being configured such that each of the pedals are coupled to both of the axle shafts acentric or offset to respective central axis defined by the ground engaging wheels; and/or wherein said pedals are located upon diametrically opposed sides of the central axis defined by the wheels such that when one pedal is at its lowest position the other pedal is at its highest position; and/or wherein the pedals are arranged to follow a rotational pattern defined by the acentric coupling to the axle shaft; and/or wherein the rotational pattern defined by the acentric coupling is an orbital pattern such as substantially circular.

7. The walking frame apparatus of claim 2, wherein the first and second sides of the frame each comprise a wing portion to which the pedal apparatus is coupled.

8. The walking frame apparatus of claim 2, wherein said frame comprises a transverse member which extends between the first and second sides to which the pedal apparatus is coupled to, typically pivotably.

9. The walking frame apparatus of claim 8, wherein said pedal apparatus comprises a single ground-engaging wheel having a single axle shaft; and/or wherein the single ground engaging wheel is located between the first and second sides of the frame with the first and second pedals being located upon either side of the ground engaging wheel.

10. The walking frame apparatus of claim 9, wherein the first and second pedals are each coupled to the axle shaft by respective linkages, the linkages each preferably comprising an elongate member which is pivotably coupled to the axle shaft at one end and the first or second pedal at the opposing end.

11. The walking frame apparatus of claim 10, wherein the linkages are configured such that each of the pedals are coupled to the axle shaft acentric or offset to the central axis defined by the ground engaging wheel with the pedals being arranged upon the linkages such that they are located upon diametrically opposed sides of the central axis.

12. The walking frame apparatus of claim 11, wherein the first and second pedals comprise elongate members, wherein each pedal is coupled to the axle shaft at one end and at the opposing end have respective footplates provided thereon.

13. The walking frame apparatus of claim 12, wherein the first and second pedals comprise a ground engageable section such as a ball caster or roller or wheel; and/or wherein the ground engageable section is located upon the underside of the pedals, typically towards the front end of the pedals.

14. The walking frame apparatus as claimed in claim 12, wherein the pedal apparatus further comprises a frame assembly comprising a base portion and a rear portion.

15. The walking frame apparatus as claimed in claim 14, wherein the base portion comprises spaced apart first and second members which define a channel therebetween within which the single ground engaging wheel is located.

16. The walking frame apparatus as claimed in claim 15, wherein the first and second pedals comprise respective displacement assembly which are configured to engage the spaced apart first and second members respectively, wherein the displacement assembly are configured to allow the pedals to displace in a linear fashion along respective portions of the first and second members; and/or wherein the first and second pedals are movably coupled to the first and second members respectively by the respective displacement assembly; and/or wherein the displacement assembly comprises a roller.

17. The walking frame apparatus as claimed in claim 16, wherein each of the displacement assembly further comprises a stopper which is operable to engage with the spaced apart first and second members to prevent the pedals from being removed therefrom in-use.

18. The walking frame apparatus of claim 12, wherein the pedals are configured to follow the rotational pattern defined by the acentric coupling of the pedals to the axle shaft by the linkages such as to establish a reciprocating motion of the pedals; and/or wherein the pedals are arranged such as to define an orbital pattern such as a substantially elliptical rotational pattern.

19. The walking frame apparatus of claim 12, wherein the pedal apparatus is located at the in-use bottom of the frame; and/or wherein a bracket is removably coupled to the frame, wherein the bracket comprises a coupling assembly configured to couple the user thereon; and/or wherein said bracket and/or the coupling assembly thereon is co-operable with a harness, provided upon the user such as to releasably couple the user upon said frame; and/or wherein said bracket comprises a base portion which is coupled to the frame and a central portion which is coupled, at least in part, to the base portion via a rail arrangement or any other suitable coupling arrangement which is configured to allow the central portion to slide or otherwise displace relative to the base portion such that the central portion may assume a plurality of extended or retracted positions.

20. A pedal apparatus for coupling to a frame, the pedal apparatus comprising:
an axle assembly comprising at least one ground-engaging wheel; and
first and second pedals coupled to the axle assembly.
